(19) United States
(12) Patent Application Publication
(10) Pub. No.: US 2024/0211998 A1
(43) Pub. Date: Jun. 27, 2024

(54) COMPUTING SYSTEM FOR TARGETING ADVERTISING AUDIENCES

(71) Applicant: MESHPLUS CO., LTD., Taipei (TW)

(72) Inventors: Kuang-Jui HU, Taipei (TW); Ying-Hsueh TSENG, Taipei (TW); Po-Hsun WANG, Taipei (TW)

(73) Assignee: MESHPLUS CO., LTD., Taipei (TW)

(21) Appl. No.: 18/601,752

(22) Filed: Mar. 11, 2024

Related U.S. Application Data
(63) Continuation-in-part of application No. 18/091,135, filed on Dec. 29, 2022.

(30) Foreign Application Priority Data
May 26, 2022 (TW) 111119612

(51) Int. Cl. G06Q 30/0251; G06F 16/14; G06Q 30/0241

(52) U.S. Cl. CPC G06Q 30/0271; G06F 16/152; G06Q 30/0255; G06Q 30/0277

(57) ABSTRACT

The present invention discloses a computing system for targeting advertising audiences, comprising a user data processing device, a user behavior characteristic processing device and a data packaging device. The user data processing device acquires a plurality set of user data serving as to-be-analyzed overall data. The user behavior characteristic processing device is connected to the user data processing device, and the user behavior characteristic processing device derives a store active visitor set from the to-be-analyzed overall data and a target user group set from the store active visitor set. The data packaging device is connected to the user behavior characteristic processing device, and the data packaging device performs a packaging process on the target user group set to obtain an advertising audience packet and transmits the advertising audience packet to an advertising platform.

### FIELD OF THE INVENTION

The present invention relates to a computing system, and more particularly relates to a computing system for targeting advertising audiences.

### BACKGROUND OF THE INVENTION

The current advertising skill is mainly performed according to “audience tags” (e.g., gender, age and interest tags) provided by an advertising platform. In other words, it depends on the conditions mentioned above to set advertising audiences as potential consumers and advertise to them. However, the current advertising skill cannot perform deeper and more precise audience targeting.

Therefore, the current advertising skill cannot fully get the characteristic profiles of the consumer group, and thus cannot precisely target the potential consumers for advertising.

### SUMMARY OF THE INVENTION

Therefore, one objective of the present invention is to provide a computing system for targeting advertising audiences, which discovers potential advertising audiences by efficiently retrieving the user data having specific behavior characteristics from a plurality set of user data so as to provide to the advertising platform.

In order to overcome the technical problems in prior art, the present invention provides a computing system for targeting advertising audiences, comprising: a user data processing device having a first processor and a data capturing unit connected to the first processor, wherein the data capturing unit is network-connected to a database device hosted by a communication service provider, the data capturing unit is controlled by the first processor and is configured to acquire, under Secure Shell File Transfer Protocol, a plurality set of user data serving as to-be-analyzed overall data from the database device, wherein each set of the user data is corresponding to one user and contains profile data, website visiting history data and offline point visiting history data, the profile data are gender, age and/or interests of the user, the website visiting history data are a visiting history of websites on which the user has visited, the offline point visiting history data are visiting history of offline points on which the user has personally visited; a user behavior characteristic processing device having a second processor, a general retrieving unit connected to the second processor and a specific retrieving unit connected to the second processor, wherein the general retrieving unit is connected to the data capturing unit of the user data processing device, the general retrieving unit is controlled by the second processor and configured to perform a hash algorithm to retrieve, according to omni-channel store list data, the user data containing the website visiting history data relating to an omni-channel store and the offline point visiting history data relating to the omni-channel store from the to-be-analyzed overall data to obtain a store active visitor set, and the specific retrieving unit is connected to the general retrieving unit, the specific retrieving unit is controlled by the second processor and configured to perform a hash algorithm to retrieve, according to data of a target store designated from the omni-channel store list data, the user data containing the website visiting history data relating to the target store and/or the offline point visiting history data relating to the target store from the store active visitor set to obtain a target user group set; and a data packaging device having a third processor and a packing unit connected to the third processor, wherein the packing unit is connected to the specific retrieving unit of the user behavior characteristic processing device, the packing unit is controlled by the third processor and configured to perform a dynamic segmentation to execute a packaging process on the target user group set to obtain an advertising audience packet relating to the target store, the advertising audience packet is used to be transmitted to an advertising platform.

In one embodiment of the present invention, a computing system for targeting advertising audiences is provided, wherein the user data processing device has a website browsing analysis unit connected to the first processor and the data capturing unit, the website browsing analysis unit is controlled by the first processor and configured to perform a distributed data process to integrate on a user identification code of the user data and the visiting history of the websites on which the user corresponding to the user identification code has visited to obtain the website visiting history data.

In one embodiment of the present invention, a computing system for targeting advertising audiences is provided, wherein the user data processing device has an offline point visiting analysis unit connected to the first processor and the data capturing unit, the offline point visiting analysis unit is controlled by the first processor and configured to perform a distributed data process to integrate on a user identification code of the user data and the visiting history of the offline points on which the user corresponding to the user identification code has visited to obtain the offline point visiting history data including longitude and latitude data of the offline point on which the user has visited.

In one embodiment of the present invention, a computing system for targeting advertising audiences is provided, wherein the user behavior characteristic processing device has a selection-condition setting unit, the selection-condition setting unit is connected to the second processor and controlled by the second processor, the selection-condition setting unit is connected to the advertising platform and configured to acquire, from the advertising platform, a target store selecting instruction designating the target store, the selection-condition setting unit is configured to perform a hash algorithm to retrieve, according to the target store selecting instruction, the user data containing the website visiting history data relating to the target store and/or the offline point visiting history data relating to the target store.

The computing system for targeting advertising audiences of the present invention has the technical effects as follows. The present invention receives a plurality set of user data in a high level of data security, efficiently retrieves specific user data responding strong consumer intention from the plurality set of user data, and provides an optimized data packaging process to produce an advertising audience packet for providing to an advertising platform.

### BRIEF DESCRIPTION OF THE DRAWINGS

FIG. 1 is a block schematic diagram illustrating a computing system for targeting advertising audiences according to one embodiment of the present invention;

FIG. 2 is a schematic diagram illustrating to-be-analyzed overall data of the computing system for targeting advertising audiences according to the embodiment of the present invention;

FIG. 3 is a schematic diagram illustrating that website visiting history data and offline point visiting history data are processed by a user data processing device of the computing system for targeting advertising audiences according to the embodiment of the present invention;

FIG. 4 is a schematic diagram illustrating that a target user group set is obtained from the to-be-analyzed overall data by the computing system for targeting advertising audiences according to the embodiment of the present invention; and

FIG. 5 is a block schematic diagram illustrating that an advertising audience packet is obtained by a user behavior characteristic processing device and a data packaging device of the computing system for targeting advertising audiences according to the embodiment of the present invention.

### DETAILED DESCRIPTION OF THE PREFERRED EMBODIMENTS

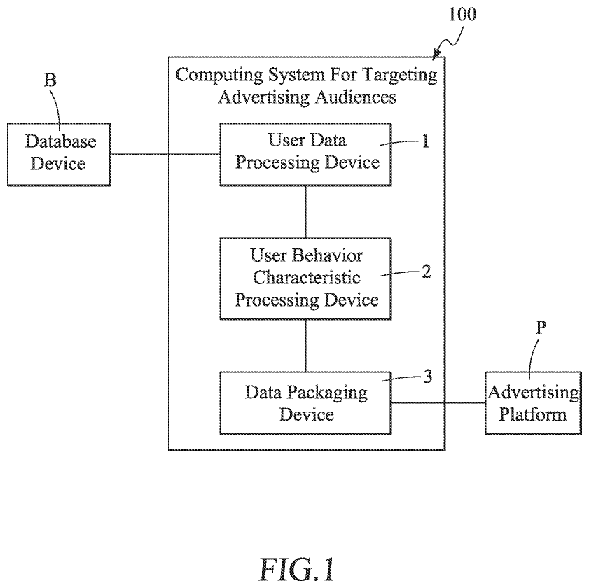

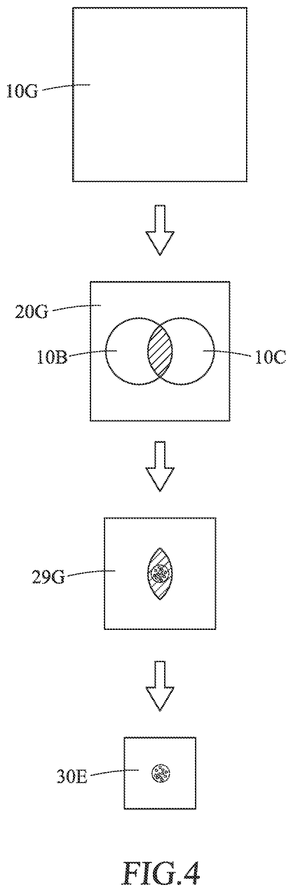

The preferred embodiments of the present invention are described in detail with reference to FIGS. 1 to 5. The description is used for explaining the embodiments of the present invention only, but not for limiting the scope of the claims.

As shown in FIGS. 1, 3 and 4, a computing system for targeting advertising audiences 100 according to one embodiment of the present invention comprises a user data processing device 1, a user behavior characteristic processing device 2 and a data packaging device 3. In this way, the computing system for targeting advertising audiences 100 of the present invention can target advertising audiences by filtering specific behavior characteristics so that the advertising platform can be guided to advertise, thereby increasing the advertising effectiveness.

As shown in FIGS. 1 to 3, the user data processing device 1 having a first processor 101 and a data capturing unit 102 connected to the first processor 101. The data capturing unit 102 is network-connected to a database device B hosted by a communication service provider. The data capturing unit 102 is controlled by the first processor 101 and is configured to acquire, under Secure Shell File Transfer Protocol a plurality set of user data 10 serving as to-be-analyzed overall data 10G from the database device B. The data capturing unit 102 may be a combination of a processor and a memory but is not limited to this.

As shown in FIGS. 1 to 3, each set of the user data 10 is corresponding to one user, and contains profile data 10A, website visiting history data 10B and offline point visiting history data 10C. Furthermore, the profile data 10A are gender, age and/or interests of the user. The website visiting history data 10B are a visiting history of websites which the user has visited. The offline point visiting history data 10C are a visiting history of offline points which the user has personally visited.

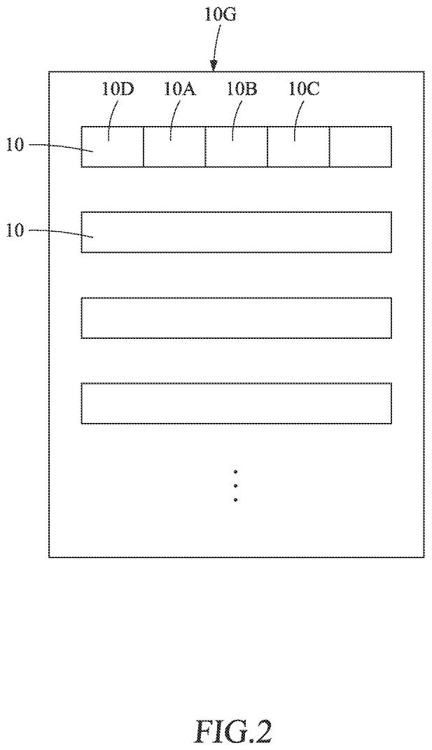

In detail, as shown in FIG. 2, according to the computing system for targeting advertising audiences 100 of one embodiment of the present invention, the user data 10 further contain a user identification code 10D, which serves as an identifier of the user data 10 corresponding to the user for data processing in the user data processing device 1.

Specifically, as shown in FIGS. 1 to 3, according to the computing system for targeting advertising audiences 100 of one embodiment of the present invention, the user data processing device 1 is connected to the database device B to receive the user data 10 from the database device B. The user identification code of the user data is obtained by performing a de-identification process (i.e., pseudonymization) on real identity features of the user in the database device B. In other words, the present invention performs the data processing and the analysis on the to-be-analyzed overall data 10G without revealing the real identity features of the individual visitor, in compliance with the Personal Data Protection Act.

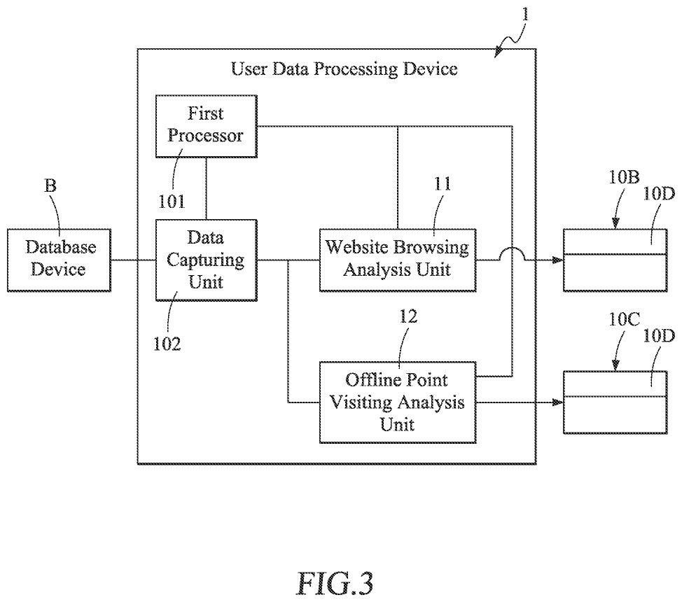

Furthermore, as shown in FIG. 3, according to the computing system for targeting advertising audiences 100 of one embodiment of the present invention, the user data processing device 1 has a website browsing analysis unit 11 connected to the first processor 101 and the data capturing unit 102. The website browsing analysis unit 11 is controlled by the first processor 101 and configured to perform a distributed data process to integrate on a user identification code 10D of the user data and the visiting history of the websites which the user corresponding to the user identification code 10D has visited to obtain the website visiting history data 10B. The website browsing analysis unit 11 may be a combination of a computer, a hard disc and a memory but is not limited to this.

In addition, as shown in FIG. 3, according to the computing system for targeting advertising audiences 100 of one embodiment of the present invention, the user data processing device 1 has an offline point visiting analysis unit 12 connected to the first processor 101 and the data capturing unit 102. The offline point visiting analysis unit 12 is controlled by the first processor 101 and configured to perform a distributed data process to integrate on the user identification code 10D and the visiting history of the offline points which the user corresponding to the user identification code 10D has visited to obtain the offline point visiting history data 10C including longitude and latitude data of the offline point on which the user has visited.

As shown in FIGS. 1, 4 and 5, the user behavior characteristic processing device 2 having a second processor 201, a general retrieving unit 202 connected to the second processor 201 and a specific retrieving unit 203 connected to the second processor 201. The general retrieving unit 202 is connected to the data capturing unit 102 of the user data processing device 1. The general retrieving unit 202 is controlled by the second processor 201 and configured to perform a hash algorithm to retrieve, according to omni-channel store list data, the user data 10 containing the website visiting history data 10B relating to an omni-channel store and the offline point visiting history data 10C relating to the omni-channel store from the to-be-analyzed overall data 10G to obtain a store active visitor set 20G. The general retrieving unit 202 may be a combination of a processor and a memory but is not limited to this.

As shown in FIGS. 1, 4 and 5, the specific retrieving unit 203 is connected to the general retrieving unit 202. The specific retrieving unit 203 is controlled by the second processor 201 and configured to perform a hash algorithm to retrieve, according to data of a target store designated from the omni-channel store list data, the user data containing the website visiting history data relating to the target store and/or the offline point visiting history data relating to the target store from the store active visitor set 20G to obtain a target user group set 29G. The specific retrieving unit 203 may be a combination of a processor and a memory but is not limited to this.

As shown in FIGS. 1, 2, 4 and 5, the data packaging device 3 has a third processor 301 and a packing unit 302 connected to the third processor 301. The packing unit 302 is connected to the specific retrieving unit 203 of the user behavior characteristic processing device 2. Moreover, the packing unit 302 is controlled by the third processor 301 and configured to perform a dynamic segmentation to execute a packaging process on the target user group set 29G to obtain an advertising audience packet 30E relating to the target store. The advertising audience packet 30E is used to be transmitted to an advertising platform P. The packing unit 302 may be a combination of a processor and a memory but is not limited to this.

As shown in FIGS. 1, 4 and 5, the data packaging device 3 transmits the advertising audience packet 30E to an advertising platform P. Therefore, the advertising platform P targets the target audiences as the advertising audiences to advertise so as to increase the advertising effectiveness of the advertising platform.

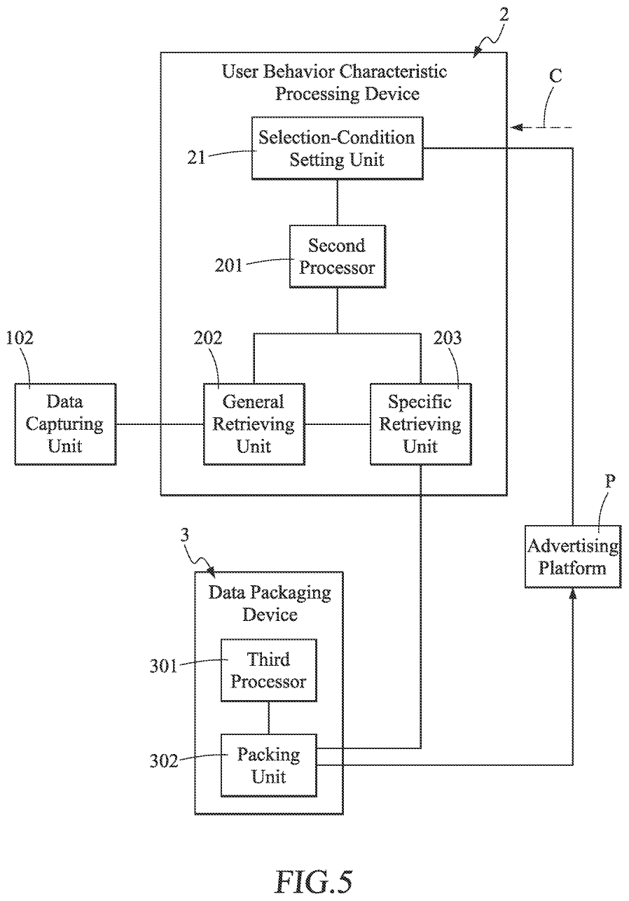

As shown in FIG. 5, according to the computing system for targeting advertising audiences 100 of the present invention, the user behavior characteristic processing device 2 has a selection-condition setting unit 21. The selection-condition setting unit 21 is connected to the second processor 201 and controlled by the second processor 201. The selection-condition setting unit 21 is connected to the advertising platform P and configured to acquire, from the advertising platform P, a target store selecting instruction C designating the target store. Furthermore, the selection-condition setting unit 21 is configured to perform a hash algorithm to retrieve, according to the target store selecting instruction C, the user data containing the website visiting history data 10B relating to the target store and/or the offline point visiting history data 10C relating to the target store.

In the present invention, the user data processing device 1 receives the plurality set of user data in a high level of data security under Secure Shell File Transfer Protocol. The user behavior characteristic processing device performs the hash algorithm to efficiently retrieve specific user data responding strong consumer intention from the plurality set of user data. The data packaging device performs a dynamic segmentation to provide the optimized data packaging process to produce the advertising audience packet for providing to an advertising platform.

It can be known from the above that the computing system for targeting advertising audiences 100 uses the user data processing device 1 and the user behavior characteristic processing device 2 to obtain the store active visitor set 20G and the target user group set 29G by retrieving the to-be-analyzed overall data 10G so that potential consumer group having the consumer intention and the characteristic profiles thereof can be obtained. Furthermore, the users “who have visited the websites and the offline points” are served as an analysis focus and considered as a potential consumer group having strong consumer intention. Therefore, the profile data 10A of the user data 10 in the target user group set 29G is processed to obtain the advertising audience packet 30E and the advertising audience packet 30E is transmitted to the advertising platform P so that the advertising platform P can target the target audiences as the advertising audiences to advertise so as to increase the advertising effectiveness of the advertising platform. In other words, the advertising audiences who have strong consumer intention can be discovered so that the advertising platform can advertise to target audiences having the specific behavior characteristics.

The above description should be considered as only the discussion of the preferred embodiments of the present invention. However, a person having ordinary skill in the art may make various modifications without deviating from the present invention. Those modifications still fall within the scope of the present invention.

What is claimed is:

1. A computing system for targeting advertising audiences, comprising:
a user data processing device having a first processor and a data capturing unit connected to the first processor, wherein the data capturing unit is network-connected to a database device hosted by a communication service provider, the data capturing unit is controlled by the first processor and is configured to acquire, under Secure Shell File Transfer Protocol, a plurality set of user data serving as to-be-analyzed overall data from the database device, wherein each set of the user data is corresponding to one user and contains profile data, website visiting history data and offline point visiting history data, the profile data are gender, age and/or interests of the user, the website visiting history data are a visiting history of websites on which the user has visited, the offline point visiting history data are visiting history of offline points on which the user has personally visited;
a user behavior characteristic processing device having a second processor, a general retrieving unit connected to the second processor and a specific retrieving unit connected to the second processor, wherein the general retrieving unit is connected to the data capturing unit of the user data processing device, the general retrieving unit is controlled by the second processor and configured to perform a hash algorithm to retrieve, according to omni-channel store list data, the user data containing the website visiting history data relating to an omni-channel store and the offline point visiting history data relating to the omni-channel store from the to-be-analyzed overall data to obtain a store active visitor set, and the specific retrieving unit is connected to the general retrieving unit, the specific retrieving unit is controlled by the second processor and configured to perform a hash algorithm to retrieve, according to data of a target store designated from the omni-channel store list data, the user data containing the website visiting history data relating to the target store and/or the offline point visiting history data relating to the target store from the store active visitor set to obtain a target user group set; and
a data packaging device having a third processor and a packing unit connected to the third processor, wherein the packing unit is connected to the specific retrieving unit of the user behavior characteristic processing device, the packing unit is controlled by the third processor and configured to perform a dynamic segmentation to execute a packaging process on the target user group set to obtain an advertising audience packet relating to the target store, the advertising audience packet is used to be transmitted to an advertising platform.

2. The computing system for targeting advertising audiences as claimed in claim 1, wherein the user data processing device has a website browsing analysis unit connected to the first processor and the data capturing unit, the website browsing analysis unit is controlled by the first processor and configured to perform a distributed data processing to integrate on a user identification code of the user data and the visiting history of the websites on which the user corresponding to the user identification code has visited to obtain the website visiting history data.

3. The computing system for targeting advertising audiences as claimed in claim 1, wherein the user data processing device has an offline point visiting analysis unit connected to the first processor and the data capturing unit, the offline point visiting analysis unit is controlled by the first processor and configured to perform a distributed data process to integrate on a user identification code of the user data and the visiting history of the offline points on which the user corresponding to the user identification code has visited to obtain the offline point visiting history data including longitude and latitude data of the offline point on which the user has visited.

4. The computing system for targeting advertising audiences as claimed in claim 1, wherein the user behavior characteristic processing device has a selection-condition setting unit, the selection-condition setting unit is connected to the second processor and controlled by the second processor, the selection-condition setting unit is connected to the advertising platform and configured to acquire, from the advertising platform, a target store selecting instruction designating the target store, the selection-condition setting unit is configured to perform a hash algorithm to retrieve, according to the target store selecting instruction, the user data containing the website visiting history data relating to the target store and/or the offline point visiting history data relating to the target store.
